(19) United States
(12) Patent Application Publication
(10) Pub. No.: US 2014/0246287 A1
(43) Pub. Date: Sep. 4, 2014

(54) DEVICE AND METHOD FOR ENSURING FUND SAFETY OF SELF-SERVICE TERMINAL USER

(71) Applicant: GRG Banking Equipment Co., Ltd., Guangzhou, Guangdong (CN)

(72) Inventors: Hongshuai Zhang, Guangzhou (CN); Zhenou Han, Guangzhou (CN); Lihua Wang, Guangzhou (CN); Jixing Tan, Guangzhou (CN); Jianhui Zhou, Guangzhou (CN); Xuejun Yang, Guangzhou (CN)

(73) Assignee: GRG Banking Equipment Co., Ltd., Guangzhou, Guangdong (CN)

(21) Appl. No.: 14/348,515

(22) PCT Filed: Mar. 27, 2013
(86) PCT No.: PCT/CN2013/073249

§ 371 Date: Mar. 28, 2014

(30) Foreign Application Priority Data
May 10, 2012 (CN) 201210143428.2

(51) Int. Cl. G07F 19/00

(52) U.S. Cl. CPC G07F 19/203
USPC 194/207

(57) ABSTRACT

A device and a method for ensuring fund safety of a self-service terminal user. The device comprises a detection module, a determination processing module, an execution module, a storage module, and a control module. In the method, after each self-service terminal user finishes a service relating to cash business, banknotes possibly existing on a small movement door is automatically recovered and processed by an automatic teller machine. By means of the device and the method, the banknotes possibly existing on the small door can be automatically recovered and processed by the automatic teller machine each time after the service relating to the cash business is finished, so the transaction speed and efficiency of the self-service terminal can be improved, and the fund safety of customers can be effectively ensured.

This application claims priority to Chinese patent application No. 201210143428.2 titled “DEVICE AND METHOD FOR ENSURING FUND SECURITY FOR SELF-SERVICE TERMINAL USER” and filed with the State Intellectual Property Office on May 10, 2012, which is incorporated herein by reference in its entirety.

### FIELD OF THE INVENTION

The present invention relates to the field of transaction security for a financial self-service terminal, and in particular to a device and method for ensuring fund security for a self-service terminal user.

### BACKGROUND OF THE INVENTION

An existing automatic teller machines (ATMs) including automatic terminal cash depositing machines and cash recycling systems, both have two doors, an outer door and a shutter of the machine core, which are provided at the banknote output opening. Wherein the machine core is the most expensive device in an ATM. The outer door performs protection, such as dust-proof, explosion-proof and water-proof, for the machine core, so that damages to the machine core caused by an external factor are effectively reduced and the life of the machine core is extended.

Presently, the two doors may be technically processed in the following two modes during cash services according to individual ATM manufacturers.

1. The two doors open and close synchronously.

The advantages of this processing mode is that the depositing user will not place a banknote on the shutter of the machine core by mistake, so that there is no need to perform a technique processing for the case wherein the cash is placed on the shutter. However, this operation mode has obvious disadvantages.

Firstly, both of the two doors have to be closed, the total time consumed in opening and closing the doors will be longer, and the speed of the transaction is affected. The shutter is lightweight and spends less time in opening and closing, generally 1 to 2 seconds. However, the outer door has a relatively large volume and is heavy. Therefore, the outer door spends more time in opening and closing, at least 2 to 4 seconds and may up to 6 to 8 seconds. Therefore, the speed of the transaction is seriously affected. For example, in the case where the client wants to deposit 5,000 yuan and the depositing is divided into five times, the two doors have to open and close five times. According to the time spent in opening and closing of the outer door which spends longer time, only the opening and closing of the doors will cost 20 to 40 seconds.

Secondly, the frequently opening and closing of the heavy outer door will reduce the life of the outer door.

Thirdly, the frequently opening and closing of the heavy outer door will increase the possibility of failure in the outer door, causing the device to fail and stop.

2. The two doors do not open and close synchronously.

In the technique processing in this mode, during one transaction period, the two doors are both open when the client performs a first cash deposit, only the shutter opens and closes during the following cash deposit, and the outer door finally closes when the transactions end.

The advantage is that the speed of the transaction is improved. In the case where the client performs multiple cash depositing, the outer door and the shutter open and close synchronously during the first deposit. Then, only the shutter opens and closes during the following cash deposit, and the outer door does not open and close and remains being open. The outer door is always open until the transactions end. Therefore, the outer door does not have to open and close multiple times, the time delayed due to the opening and closing of the outer door is saved, and the speed of the transaction is improved. For example, in the case where the client wants to deposit 5,000 yuan and the cash depositing is divided into five times, the shutter has to open and close five times. The time spent in the first opening is counted on the basis of the time spent in opening and closing of the outer door which spends longer time and ranges from 3 to 6 seconds, and only the shutter opens and closes in the following 4 deposits and this spends 4 to 16 seconds. Thus totally 7 to 22 seconds are needed, saving almost a half of time compared with the mode in which the two shutters open and close synchronously.

Although this mode improves the speed of the transaction, there is potential fund security risk. Since the outer door opens during the first deposit, and then, only the shutter opens and closes during the following cash deposit, and the outer door remains being open. Therefore, when there is a rejected banknote during counting of the banknotes, the client is inclined to put a banknote on the cover of the shutter by mistake because the client is not familiar with the operation process. When the transactions end and the outer door being closed, the banknote will be left on the cover of the shutter. Since the banknote on the cover of the shutter cannot be detected, there exists the fund security risk.

Firstly, the banknote itself is not safe. The banknote is inside the outer door, a criminal can get to know whether there is the banknote on the shutter by various ways and then open the door to take the banknote as his/her own.

Secondly, if next person performs a cash deposit, when the door opens, he/she may take away the banknote put on the cover of the shutter by the previous person, which cannot be judged and sensed by a control system of the self-service terminal, causing fund loss to the client.

In the mode wherein the two shutters do not open and close synchronously, if the banknote appearing on the shutter of the machine core due to various reasons is not effectively handled in time, the client may suffer from the fund loss. The account disputes between the client and the bank will be increased. The quality of service and the client figure of ATM are affected, and client confidence in ATM is reduced. The cost of the bank is increased. Even the credit of the bank may be seriously affected, leading to reduction in the social credit of the bank and tense relationship between the bank and the client.

Therefore, in the technical field of ATM, a device and method which can both improve the speed and efficiency of the transaction and effectively ensure fund security for the client is desired, so as to improve the quality of service of ATM and to maintain the transaction credit for the bank.

### SUMMARY OF THE INVENTION

The object of the invention is to provide a device and method for ensuring fund security for a self-service terminal user, so that ATM automatically retracts the banknote which may be left on the shutter each time after a cash related service ends, thereby the speed and efficiency of the transaction of ATM are improved and fund security for the client is effectively ensured.

The invention provides a device for ensuring fund security for a self-service terminal user, including: a detecting module, provided at a deposit/withdrawal opening and configured to detect whether there is a banknote fallen into the deposit/withdrawal opening when a shutter of a machine core is shaking and closing; a determining and processing module, configured to determine the type of a transaction, and when a cash related transaction ends, send to an execution module an instruction that instructs to shake the shutter; and when there is a banknote fallen into the deposit/withdrawal opening, send to the machine core an instruction that instructs to retract the banknote; the execution module, being the shutter of the machine core, open the shutter of the machine core while driven by a motor so that a banknote which may be left on the shutter falls into the machine core; a storage module, configured to store the number of the retracted banknotes and a result of the retraction, for banknote clearance and account verification in a banknote adding period of the self-service; and a control module, configured to control interaction between the above modules.

Furthermore, the detection module may include a unit for detecting whether there is a banknote fallen into the shutter and a unit for detecting the open/closing state of the door.

Furthermore, the determining and processing module may include a service type determining unit and a service ending determining unit.

Furthermore, the execution module may include an execution unit for retracting the banknote, an execution unit for closing the outer door and an execution unit for shaking the shutter.

The invention further provides a method for ensuring fund security for a self-service terminal user, including:

S1: determining whether a transaction is in relation to cash service, and proceeding to S2 if the transaction is in relation to cash service; otherwise, ending;

S2: shaking a shutter of a machine core, detecting whether there is a banknote fallen into the shutter, and proceeding to S3 if there is a banknote fallen into the shutter; otherwise, ending;

S3: retracting the banknote; and

S4: associating the retracted cash with a user account that performs the most recent transaction, and recording the retracted cash as deposit of the user account that performs the most recent cash service.

Furthermore, the transaction in relation to cash may be only a depositing transaction or/and a withdrawing transaction.

Furthermore, the retracting is needed to be performed after a cash transaction of each user ends and before the next service on the self-service terminal.

Furthermore, the shaking of the shutter the machine core is: opening the shutter, and closing the shutter with a delay.

Compared with the prior art, the solution according to the invention achieves the following notable technical effects.

1. The device and method for ensuring fund security for a self-service terminal user that is provided by the invention can determine whether it is needed to effectively retract the banknote which may be left on the shutter of the machine core before the next service starts, based on whether the service just performed by ATM is a depositing/withdrawing service in relation to cash operation, thereby achieve the goal of ensuring fund security for the client.

2. The design of the product meets the needs of the existing self-service terminal, thereby avoiding the fund loss for the client of the bank self-service terminal, reducing the account disputes between the bank and the client, and improving the quality of service and the client figure of the self-service product. This has enormous economic significance and social significance.

### BRIEF DESCRIPTION OF THE DRAWINGS

FIG. 1 is a structural schematic view of a device according to the invention;

FIG. 2 is a flow chart of multiple depositing transactions during one transaction period according to a method of the invention;

FIG. 3 is a flow chart of multiple withdrawing transactions during one transaction period according to the method of the invention; and

FIG. 4 is a flow chart of a transaction with a client fund security process according to the method of the invention.

### DETAILED DESCRIPTION OF THE INVENTION

To make the above object, technical solution and advantages of the invention more obvious, in the following, the invention will be illustrated further in detail in conjunction with the drawings.

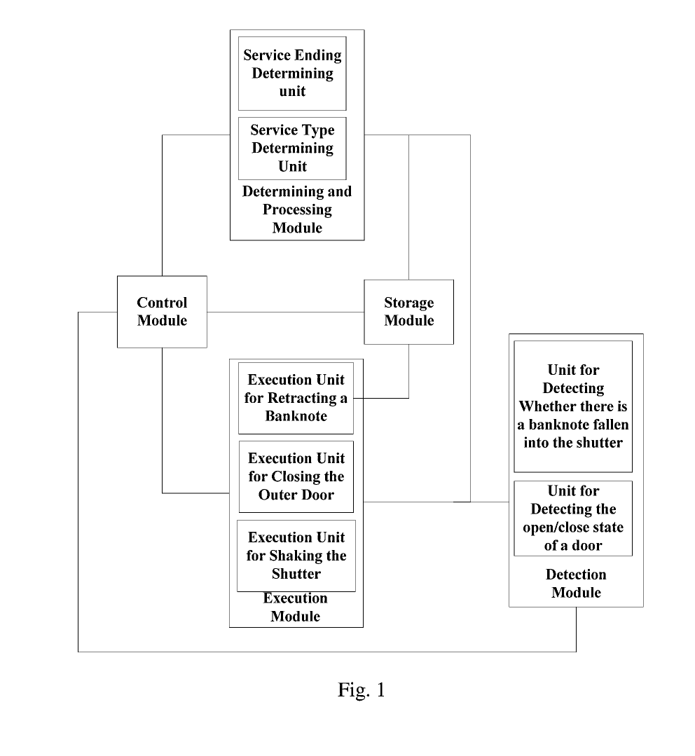

Referring to FIG. 1 which is a structural schematic view of modules included in the invention, an embodiment of the invention includes a detection module, a determining and processing module, an execution module, a storage module and a control module.

1) The detection module is provided at a deposit/withdrawal opening and is configured to detect whether there is a banknote fallen into the deposit/withdrawal opening when a shutter of a machine core is shaking or closing. This module includes a unit for detecting whether there is a banknote fallen into the shutter and a unit for detecting the open/closing state of a door. The unit for detecting whether there is a banknote fallen into the shutter detects whether there is a banknote shaken and fallen at the banknote output opening. The unit for detecting the open/closing state of a door detects whether the outer door is in the open state or in the closing state.

2) The determining and processing module is configured to determine the type of a transaction, and when a cash related transaction ends, send to an execution module an instruction that instructs to shake the shutter; and when there is a banknote fallen into the deposit/withdrawal opening, send to the machine core an instruction that instructs to retract the banknote. This module includes a service type determining unit and a service ending determining unit. The service type determining unit determines whether a service is a cash-related transaction. The service ending determining unit determines whether a service ends.

3) The execution module is the shutter of the machine core and opens the shutter of the machine core while driven by a motor so that a banknote which may be left on the shutter falls into the machine core. This module includes an execution unit for retracting the banknote, an execution unit for closing the outer door and an execution unit for shaking the shutter. The execution unit for retracting the banknote retracts the banknote shaken and fallen at the banknote output opening. The execution unit for closing the outer door performs the closing operation of the outer door. The execution unit for shaking the shutter opens the shutter and closes the shutter with a delay.

4) The storage module is configured to store the number of the retracted banknotes and a result of the retraction, to facilitate banknote clearance and account verification in a banknote adding period of the self-service terminal

5) The control module is configured to control the operations of the above modules.

The invention further provides a method for ensuring fund security for a user in a depositing/withdrawing transaction on a self-service terminal, including:

S1: determining whether a transaction is in relation to cash, and proceeding to S2 if the transaction is in relation to cash; otherwise, ending;

S2: shaking a shutter of a machine core, detecting whether there is a banknote fallen into the shutter, and proceeding to S3 if there is a banknote fallen into the shutter; otherwise, ending;

S3: retracting the banknote; and

S4: associating the retracted cash with a user account that performs the most recent transaction, and recording the retracted cash as deposit of the user that performs the most recent cash service.

Furthermore, the service in relation to cash is only a depositing service or/and a withdrawing service.

Furthermore, the retracting is needed to be performed after a cash transaction of each user ends and before the next transaction on the self-service terminal

Furthermore, the shaking of the shutter includes: opening the shutter, and closing the shutter with a delay.

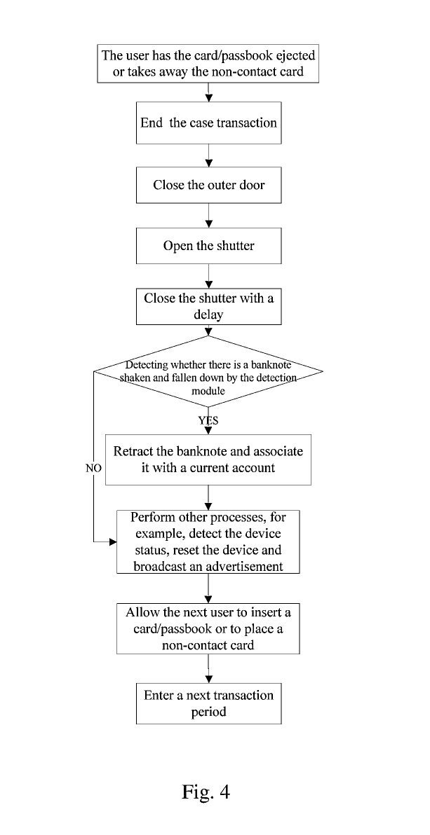

Referring to FIG. 4, according to the method, after a cash-related transaction of each user ends, ATM may automatically retract the banknote which may exist on the shutter.

Furthermore, according to the method of the invention for ensuring fund security for a self-service terminal user, the retracting of a banknote is only required when the most recent transaction may cause a banknote to be left on the shutter of the machine core. Specifically, a banknote may be left on the shutter of the machine core only after the depositing service performed on the depositing machine and the withdrawing service performed on the cash recycling system. There is no need for the retracting of a banknote in the case of the cash withdrawing service performed on a single-function withdrawing machine.

Furthermore, according to the method of the invention for ensuring fund security for a self-service terminal user, it is determined whether the most recent service performed is a depositing/withdrawing service. Since the depositing/withdrawing service relates to a cash operation and as a result there may be a banknote left on the shutter of the machine core. Therefore, before a next service, the banknote which may exist on the shutter should be handled.

Furthermore, according to the method of the invention for ensuring fund security for a self-service terminal user, the ATM will retract the banknote which may exists on the shutter in a following way. When any depositing or withdrawing service ends, before the next service begins, a control system of the self-service terminal sends an instruction that instructs to shake the shutter multiple times while the outer door is kept closed; thereby, the banknote, if any, left on the shutter may fall into the machine core; the machine core detects that there is a fallen banknote and will send an instruction that instructs to retract the banknote. Therefore, the banknote left on the shutter can be effectively retracted and be recorded in the account money of the user that performs a most recent withdrawing operation, such that the fund loss of the user is prevented and the fund security for the user is ensured.

Furthermore, according to the method of the invention for ensuring fund security for a self-service terminal user, the shaking of the shutter includes: opening the shutter, and closing the shutter with a delay. Performing the shaking for 1 to 5 times is OK.

Furthermore, according to the method of the invention for ensuring fund security for a self-service terminal user, the banknote which may be left on the shutter is retracted by shaking the shutter. The retracting is performed after a cash transaction of one user ends and before a transaction of the next user begins. The shaking and retracting may be performed once immediately after the cash transaction of each user ends and the retracted cash may be associated with the user account. If the shaking and retracting are performed before a first cash transaction in each banknote adding period, the retracted cash will be undetermined

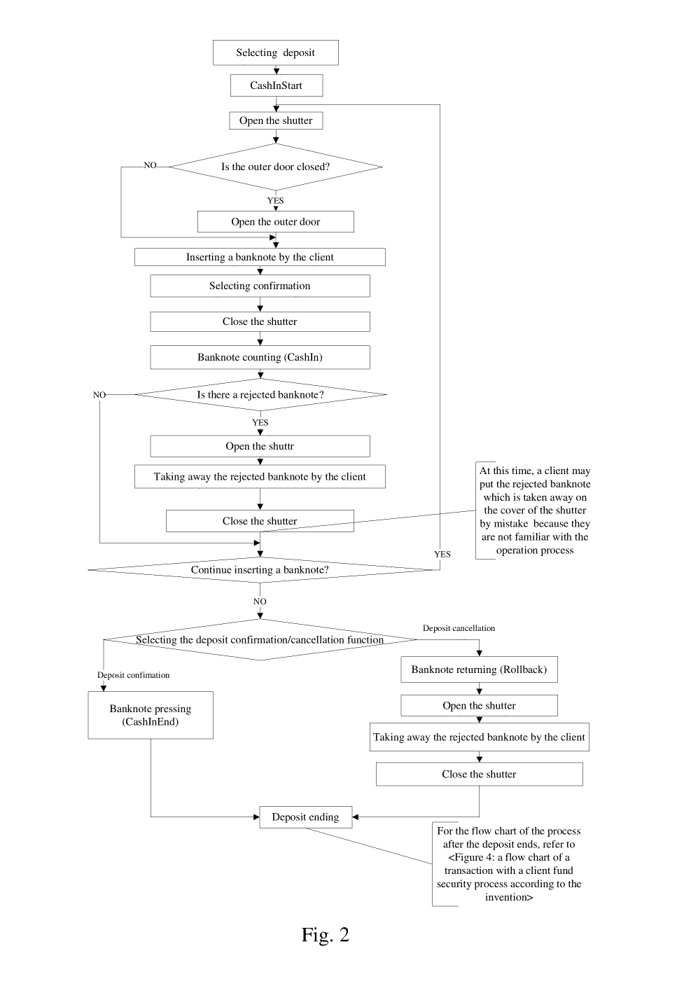

Reference is made to FIG. 2 which is a flow chart after multiple depositing transactions during one transaction period according to the method of the invention for ensuring fund security for a self-service terminal user.

During one transaction period, the two doors are both open when the client performs a first deposit, only the shutter opens and closes during the following depositing, and the outer door is always open until the transactions end. Since the client may leave a banknote on the cover of the shutter of the machine core during the depositing process. Therefore, after the transaction period ends, ATM will automatically retract the banknote which may exists on the shutter. The specific steps are as follows.

1) ATMC allows insertion of a card/passbook or to place a non-contact card or waits for no-card deposit while broadcasting an advertisement and so on.

2) In the case where a client inserts a card/passbook or places a non-contact card, the number of the card or account is read. Alternatively, in the case where the client performs the no-card deposit, the number of the card or account is input.

3) A card/passbook is inserted or a non-contact card is placed, and an interface displays functions such as deposit, withdrawal, inquiry, transfer, changing a password and exit, etc. In the case of the no-card deposit, the interface displays functions such as deposit, and exit, etc. The client selects the deposit function and performs the depositing transaction.

4) ATMC executes a deposit initiating (CashInStart) instruction, and performs preprocessing before the deposit.

5) ATMC executes an open shutter (Openshutter) instruction to open the shutter of the machine core, and to open the outer door if the outer door is closed or perform no operation to the outer door if it is open. The interface prompts the client to insert a banknote.

6) The client inserts a banknote (Insert) and selects a confirmation to indicate that the banknote is inserted.

7) ATMC executes instructions of close shutter (CloseShutter) and banknote counting (CashIn) to close the shutter of the machine core and verify the banknote. If the verification succeeds, the genuine banknote is sent to a temporary storage region; otherwise, the counterfeit or broken banknote is sent to a banknote output opening as a rejected banknote.

8) In the case where there is the rejected banknote at the banknote output opening, ATMC executes the OpenShutter instruction to open the shutter of the machine core and prompts the client to take away the rejected banknote at the banknote output opening. After the client take away (Taken) the rejected banknote, ATMC executes the CloseShutter instruction to close the shutter of the machine core. At this time, some clients may often put the rejected banknote on the cover of the shutter of the machine core by mistake because they are not familiar with the operation process.

9) The interface displays a continual banknote insertion function and a banknote insertion ending function. If the client selects the continual banknote insertion function, the flow chart jumps to 5).

10) The interface displays a deposit confirmation function and a deposit cancellation function.

11) If the client selects the deposit confirmation function, ATMC executes a banknote pressing (CashInEnd) instruction to deliver the banknote from the temporary storage region to a cash deposit box or a circulation box or a retraction box.

12) If the client selects the deposit cancellation function, ATMC executes a banknote returning (Rollback) instruction to deliver the banknote from the temporary storage region to the banknote output opening. ATMC executes the OpenShutter instruction to open the shutter of the machine core and prompts the client to take away the returned banknote at the banknote output opening. After the client take away (Taken) the rolled back banknote, ATMC executes the CloseShutter instruction to close the shutter of the machine core.

13) The client has the card/passbook ejected (Eject Card), and the cash transaction ends; the client takes away the non-contact card, and the cash transaction ends; the client exits the no-card deposit, and the cash transaction ends.

14) ATMC executes the CloseShutter instruction to close the outer door and to open the shutter and close the shutter with a delay. If there is a banknote shaken and fallen into the deposit/withdrawal opening, ATMC executes a retracting (Retract) instruction to associate the retracted cash with the current account storage, so as to ensure the fund security for the user.

15) The flow chart jumps to 1) and the next transaction period begins.

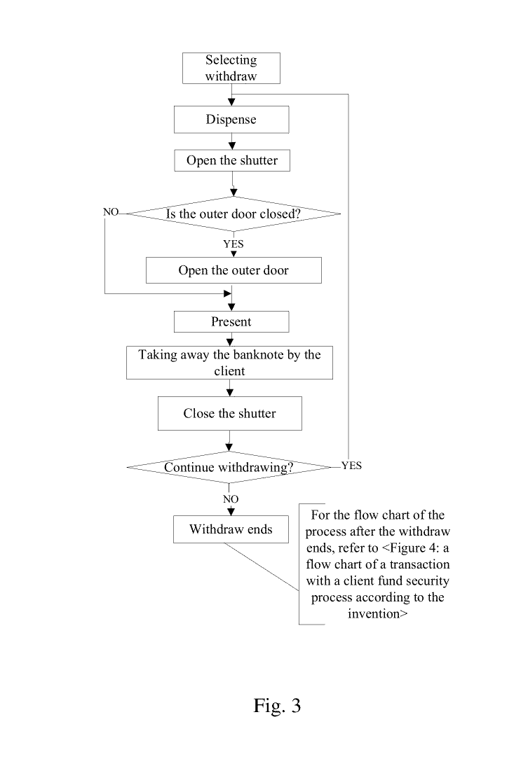

Reference is made to FIG. 3 which is a flow chart after multiple withdrawing services during one transaction period according to the method of the invention for ensuring fund security for a self-service terminal user.

During one transaction period, the two doors are both open when the client performs a first withdrawal, only the shutter opens and closes during the following cash withdrawing transactions, and the outer door is always open until the transactions end. Since the client may leave a banknote on the cover of the shutter of the machine core during the withdrawing process. Therefore, after the transaction period ends, ATM may automatically retract the banknote which may exists on the shutter. The specific steps are as follows.

1) ATMC allows to put into a card/passbook or to place a non-contact card while broadcasting an advertisement and so on.

2) In the case where a client inserts a card/passbook, the number of the card or account is read. In the case where the client places a non-contact card, the number of the card is directly read.

3) An interface displays functions such as deposit, withdrawal, inquiry, transfer, changing a password and exit. The client selects the withdrawal function and performs the withdrawing transaction.

4) ATMC executes a withdrawing (Dispense) instruction to take a banknote out of a banknote box and deliver the banknote to a temporary storage region.

5) ATMC executes a banknote delivering (Present) instruction to open the shutter of the machine core, and to open the outer door if the outer door is closed or perform no operation to the outer door if the outer door is open, and to deliver the banknote from the temporary storage region to the banknote output opening. The interface prompts the client to take away the banknote.

6) After the client take away (Taken) the banknote, ATMC executes a CloseShutter instruction to close the shutter of the machine core.

7) The interface continually displays the functions such as deposit, withdrawal, inquiry, transfer, changing a password, and exit. If the client selects the withdrawal function, the flow chart jumps to 4) and the withdrawing transaction is continually performed.

8) The client has the card/passbook ejected (Eject Card), and the cash transaction ends; the client takes away the non-contact card, and the cash transaction ends.

9) ATMC executes the CloseShutter instruction to close the outer door and to open the shutter and close the shutter with a delay. If there is a banknote shaken and fallen into the deposit/withdrawal opening, ATMC executes a Retract instruction to associate the retracted cash with the current account storage, so as to ensure the fund security for the user.

10) The flow chart jumps to 1) and the next transaction period begins.

Those described above are only the better embodiments of the present invention and are not intended to define the scope of protection of the present invention. It should be noted that several improvement and changes can be made by those skilled in the art without deviation from the principle of the present invention. Therefore, these improvement and changes should fall within the scope of protection of the present invention.

1. A device for ensuring fund security for a self-service terminal user, comprising:
a detection module, provided at a deposit/withdrawal opening and configured to detect whether there is a banknote fallen into the deposit/withdrawal opening when a shutter of a machine core is shaking and closing;
a determining and processing module, configured to determine the type of a transaction, and when a cash related transaction ends, send to an execution module an instruction that instructs to shake the shutter; and when there is a banknote fallen into the deposit/withdrawal opening, send to the machine core an instruction that instructs to retract the banknote;
the execution module, being the shutter of the machine core, configured to open the shutter of the machine core while driven by a motor so that a banknote which may be left on the shutter falls into the machine core;
a storage module, configured to store the number of the retracted banknotes and a result of the retraction, for banknote clearance and account verification in a banknote adding period of the self-service; and
a control module, configured to control an interaction between the above modules.

2. The device for ensuring fund security for a self-service terminal user according to claim 1, wherein the detection module comprises a unit for detecting whether there is a banknote fallen into the shutter and a unit for detecting the open/closing state of a door.

3. The device for ensuring fund security for a self-service terminal user according to claim 1, wherein the determining and processing module comprises a service type determining unit and a service ending determining unit.

4. The device for ensuring fund security for a self-service terminal user according to claim 1, wherein the execution module comprises an execution unit for retracting the banknote, an execution unit for closing the outer door and an execution unit for shaking the shutter.

5. A method for ensuring fund security for a self-service terminal user, comprising:
S1: determining whether a transaction is in relation to cash, and proceeding to S2 if the transaction is in relation to the cash; otherwise, ending;
S2: shaking a shutter of a machine core, detecting whether there is a banknote fallen into the shutter, and proceeding to S3 if there is a banknote fallen into the shutter; otherwise, ending; and
S3: retracting the banknote.

6. The method for ensuring fund security for a self-service terminal user according to claim 5, further comprising:
S4: associating the retracted cash with a user account that performs the most recent transaction, and recording the retracted cash as deposit of the user that performs the previous case service.

7. The method for ensuring fund security for a self-service terminal user according to claim 5, wherein the service in relation to cash is only a depositing service or/and a withdrawing service.

8. The method for ensuring fund security for a self-service terminal user according to claim 5, wherein the retracting is needed to be performed after a cash transaction of each user ends and before the next service on the self-service terminal.

9. The method for ensuring fund security for a self-service terminal user according to claim 5, wherein the shaking of the shutter comprises: opening the shutter, and closing the shutter with a delay.
